(19) United States
(12) Patent Application Publication
(10) Pub. No.: US 2013/0262182 A1
(43) Pub. Date: Oct. 3, 2013

(54) PREDICTING PURCHASE INTENT BASED ON AFFECT

(71) Applicant: AFFECTIVA, INC., Waltham, MA (US)

(72) Inventors: Evan Kodra, Cambridge, MA (US); Daniel Bender, Cambridge, MA (US); Rana el Kaliouby, Waltham, MA (US); Mohamed Nada, Cairo (EG)

(73) Assignee: Affectiva, Inc., Waltham, MA (US)

(21) Appl. No.: 13/768,288

(22) Filed: Feb. 15, 2013

Related U.S. Application Data
(60) Provisional application No. 61/618,750, filed on Mar. 31, 2012.

(51) Int. Cl. G06Q 30/02

(52) U.S. Cl. CPC G06Q 30/0202
USPC 705/7.31

(57) ABSTRACT

Analysis of mental states is provided to evaluate purchase intent. Purchase intent may be determined based on viewing and sampling various products. Data is captured for viewers of a product where the data includes facial information, physiological data, and the like. Facial and physiological information may be gathered for a group of viewers. In some embodiments, demographics information is collected and used as a criterion for evaluating product or service purchase intent. In some embodiments, data captured from an individual viewer or group of viewers is used to optimize product purchase intent.

### RELATED APPLICATIONS

This application claims the benefit of U.S. provisional patent application “Predicting Purchase Intent Based on Affect” Ser. No. 61/618,750, filed Mar. 31, 2012. The foregoing application is hereby incorporated by reference in its entirety.

### FIELD OF ART

This application relates generally analysis of mental states and more particularly to purchase intent prediction based on affect.

### BACKGROUND

Evaluation of mental states is key to understanding people and the way in which they react to the world around them. People's mental states may vary across a wide range from happiness to sadness, from contentedness to worry, from excited to calm, as well as numerous other mental states. These mental states are experienced in response to everyday events such as frustration during a traffic jam, boredom while standing in line, and enjoyment of a cup of coffee. Individuals may become quite perceptive and empathetic to those around them based on evaluating and understanding others' mental states. While an empathetic person may with ease perceive another's being anxious or joyful and thus respond accordingly, automated evaluation of mental states is a far more challenging undertaking The ability and means by which one person perceives another's emotional state may be quite difficult to summarize or relate and has often been communicated as having resulted from a “gut feel.”

Confusion, concentration, and worry may be identified by various means in order to aid in the understanding of the mental states of an individual or group of people as they react to a visual stimulus. For example, people can collectively respond with fear or anxiety that may result from witnessing a catastrophe. Likewise, people can collectively respond with happy enthusiasm, such as when their sports team wins a major victory. Certain facial expressions and head gestures may be used to identify a mental state that a person or a group of people is experiencing. Limited automation has been performed in the evaluation of mental states based on facial expressions. Certain physiological conditions may further provide telling indications of a person's state of mind. These physiological conditions have been used to date in a crude fashion such as in an apparatus used for polygraph tests.

### SUMMARY

Analysis of people, as they interact with various products and services may be useful in evaluating their probability of purchasing a product or service in the future. People's reactions as they view or experience a product can be telling indicators of their enthusiasm and desire for the product. In some embodiments, a product can be smelled or touched, with persons' responses to such smelling and touching obtained and used. A computer implemented method for learning purchase behavior is disclosed comprising: collecting mental state data from a plurality of people as they are experiencing a product; analyzing the mental state data to produce mental state information; and projecting purchase intent based on the mental state information. The experiencing may include one of smelling, viewing, or touching. The viewing may include viewing on an electronic display. The method may further comprise collecting self reporting from the plurality of people. The self reporting may include information on whether individuals, from the plurality of people, plan to purchase the product. The method may further comprise collecting information on whether individuals from the plurality of people eventually purchase the product. The analyzing the mental state data may further include pre-processing the mental state data, wherein the pre-processing comprises one or more of machine learning, filtering, smoothing, and segmenting by time. The analyzing the mental state data may further comprise post-processing the mental state data wherein the post-processing includes one or more of detecting peaks, detecting durations, detecting magnitudes, detecting rise times, and detecting fall times. The analyzing may further comprise fitting statistical models to the mental state data. The method may further comprise selecting one or more of the statistical models for use in the projecting of the purchase intent. The selecting may be based on a search of the statistical models to identify a subset of the statistical models which correlate to a reported purchase intent. The reported purchase intent may include one of a plan to purchase and a history of purchasing. The method may further comprise validating the one or more statistical models. The validating may include one or more of checking the one or more statistical models and optimizing coefficients for the one or more statistical models.

The purchase intent may be represented as a binary value. The purchase intent may be represented as a probability. The method may further comprise aggregating the mental state information into an aggregated mental state analysis which is used in the projecting. The mental state data may include one of a group comprising physiological data, facial data, and actigraphy data. The facial data may include one or more of valence, action unit 4, and action unit 12. The physiological data may include electrodermal activity. The analyzing may include evaluating a fastest decay for the electrodermal activity. A webcam may be used to capture one or more of the facial data and the physiological data. The method may further comprise inferring mental states about the product based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

In embodiments, a computer program product embodied in a non-transitory computer readable medium for learning purchase behavior may comprise: code for collecting mental state data from a plurality of people as they experience a product; code for analyzing the mental state data to produce mental state information; and code for projecting purchase intent based on the mental state information. In some embodiments, a computer system for learning purchase behavior may comprise: a memory which stores instructions; one or more processors attached to the memory wherein the one or more processors, when executing the instructions which are stored, are configured to: collect mental state data from a plurality of people as they experience a product; analyze the mental state data to produce mental state information; and project purchase intent based on the mental state information. In embodiments, a computer implemented method for learning purchase behavior may comprise: collecting mental state data from a plurality of people as they experience a product, wherein the experience includes one of touching and smelling, and wherein the mental state data includes electrodermal activity; analyzing the mental state data to produce mental state information wherein the analyzing includes evaluating a fastest decay for the electrodermal activity; and projecting purchase intent based on fastest decay for the electrodermal activity.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for analyzing purchase intent.

FIG. 2 is a system diagram representing physiological analysis.

FIG. 3 is a system diagram for capturing facial response to product.

FIG. 4 is a spreadsheet of statistical analysis of purchase intent.

FIG. 5 is a graph of coefficient values.

FIG. 6 is a graphical representation of mental state analysis.

FIG. 7 is a graph of purchase probability.

FIG. 8 is a system diagram for analyzing mental state information.

### DETAILED DESCRIPTION

The present disclosure provides a description of various methods and systems for affect-based evaluation of response to a product. The affect-based evaluation is based on analyzing people's mental states, particularly when evaluating a product or service. An accurate determination of which products or services generate favorable reactions in potential purchasers is useful to indicate the greatest likelihood to purchase. A method and system capable of accurately predicting purchase likelihood is of tremendous value to designers, developers, marketers, and the like, of potential products and services.

Potential buyers may observe products and have data collected on their mental states. Mental state data from a plurality of people may be processed to form aggregated mental state analysis, which then may be used in projecting the product purchase intent of potential buyers. Based on the projected purchase intent for a product, the product may be optimized. Computer analysis may be performed on facial and/or physiological data to determine people's mental states as they experience various types of products. A mental state may be a cognitive state, an emotional state, or a combination thereof. Examples of emotional states may include happiness or sadness, while examples of cognitive states may include concentration or confusion. Observing, capturing, and analyzing these mental states can yield significant information about people's reactions to various stimuli.

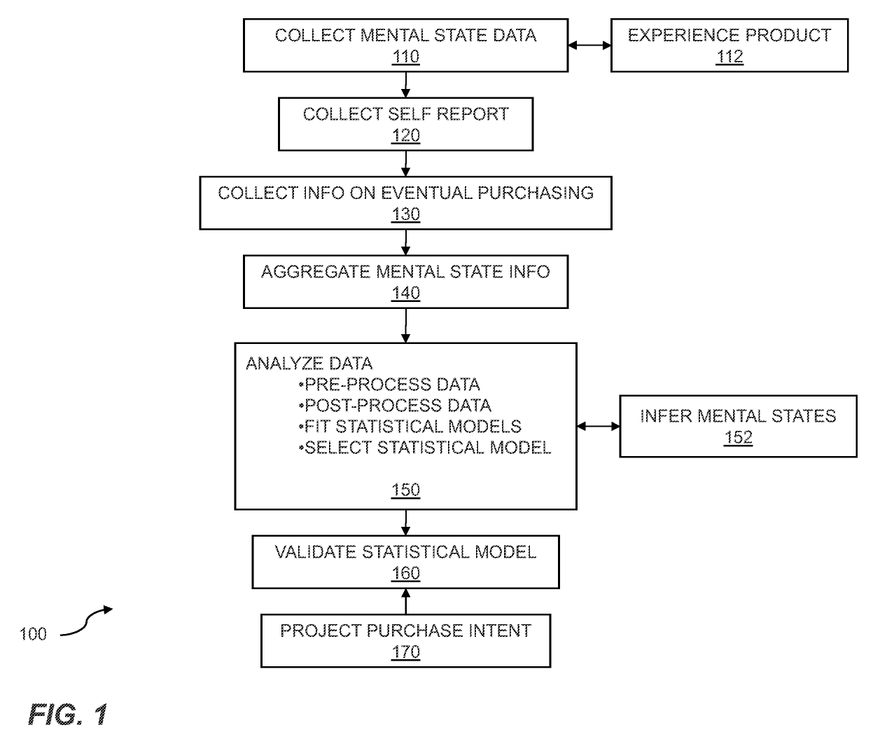

FIG. 1 is a flow diagram for analyzing purchase intent. The flow 100 describes a computer-implemented method for learning purchase behavior. The method may comprise collecting mental state data from a plurality of people as they experience a product, analyzing the mental state data to produce mental state information, and projecting purchase intent. The evaluation may be based on analysis of collected mental state data gathered from a plurality of people. A plurality of people may comprise a potential buyer or group of potential buyers. The evaluation may further be based on physiological data gathered from a potential buyer or plurality of potential buyers.

The flow 100 begins with collecting mental state data 110 from a plurality of people as they experience a product. A person or a plurality of people may be experiencing the product directly so that they may, for example, touch, see, and smell the product. In other embodiments, the person or plurality of people may experience a rendering of the product. The rendering of a product may include a series of images, a video, a series of sketches, an animatic, or the like. The rendering may comprise images, text, background, video, and the like. In embodiments, any or all these elements may be present.

The flow 100 includes the collecting of mental state data 110 from a person or a plurality of people as they are exposed to a product. The mental state data may include facial data, physiological data, and the like. Facial data may be obtained from video observations of a person or a plurality of people. The facial data may include action units, head gestures, smiles, brow furrows, squints, lowered eyebrows, raised eyebrows, attention, and the like. The collecting of mental state data may also comprise collecting one or more of physiological data and actigraphy data. Physiological data may also be obtained from video observations of a person or a plurality of people. For example, heart rate, heart rate variability, autonomic activity, respiration, and perspiration may be observed via video capture. Alternatively, in some embodiments, a biosensor may be used to capture physiological information and may also be used to capture accelerometer readings. In some embodiments, permission is requested and obtained prior to the collection of mental state data. A person or plurality of people may observe a product or products synchronously or asynchronously.

The collecting of mental state data 110 from a person or a plurality of people may be part of a product purchase intent prediction process. Mental state data gathering 110 may be accomplished with a camera such as a webcam, a camera on a computer (such as a laptop, a net-book, a tablet, or the like), a video camera, a still camera, a cell phone camera, a mobile device camera (including, but not limited to, a forward facing camera), a thermal imager, a CCD device, a three-dimensional camera, a depth camera, multiple webcams used to capture different views of potential buyers, or any other type of image capture apparatus which may allow image data captured to be used by an electronic system.

The product experience 112 may include smelling, viewing, or touching the product. The product experience may further include monitoring of electrodermal activity (EDA). The product experience may also include displaying on an electronic display a rendering related to a product. The electronic display may be any electronic display, including but not limited to, a computer display, a laptop screen, a net-book screen, a tablet computer screen, a cell phone display, a mobile device display, a television, a projector, or the like. The product may include any type of product.

The flow 100 includes collecting self-reporting responses 120 from a single person or a plurality of people who are experiencing a product. The self-reporting may include information on whether individuals from among the plurality of people plan to purchase the product. The self-reporting may include collecting responses to questions about the product from the plurality of people. Further, the collected responses may constitute self-reporting, and the self-reporting may be correlated to mental state data which has been collected. In some embodiments, mental state data may be collected as the potential buyer responds to the questions. In embodiments, the mental state data may be compared with the self-report data collected from the group of potential buyers. In this way, the analyzed mental states may be compared with the self-report information to see how well the two data sets correlate. In some instances, potential buyers may self-report intent to purchase, which may differ from their true mental state. For example, in some cases people may self-report a certain mental state because they feel it is the “correct” response or they are embarrassed to report their true mental state. The self-report comparison can serve to identify products where the analyzed mental state deviates from the self-reported mental state.

The flow 100 continues with collecting information which may include information specifying whether individuals from the plurality of people eventually purchased the product 130. Such information may be compared with the self-reporting information collected from a plurality of potential buyers to determine a correlation between self-reporting information, mental state information, and individuals' eventual purchasing behavior.

The flow 100 continues with aggregating mental state information 140. The aggregation of the mental state information gathered from a plurality of people may be used to create an aggregated mental state analysis. The aggregated mental state analysis of the aggregated mental state information gathered from a plurality of people may be used in projecting purchase intent of an individual or individuals.

The flow 100 continues with analyzing the mental state data to produce mental state information 150. The mental state data analysis may include evaluating the fastest decay for the electrodermal activity. The analyzing of the mental state data may further include preprocessing of the mental state date. The pre-processing may compromise one or more of machine learning, filtering, smoothing, segmenting by time, and the like. The analyzing of the mental state data may further comprise post-processing of the mental state data. The post-processing may include one or more of detecting peaks, detecting durations, detecting magnitudes, detecting rise times, detecting fall times, and the like. The analyzing may further comprise fitting statistical models to the mental state data. The fitting of statistical models may involve one model or a plurality of models. The flow 100 may continue with selecting one or more of the statistical models to project the eventual purchase intent of a potential buyer or plurality of potential buyers who experience a product. The selection of one or more statistical models may be based on a search of the statistical models to identify a subset of the statistical models which correlate to the reported purchase intent.

The flow 100 continues with inferring mental states 152 of the potential buyer or a plurality of potential buyers who experience a product. The mental state data which may be gathered may include one or more of a group comprising physiological data, facial data, and actigraphy data. The facial data may include one or more of valence, action unit 2, action unit 4, action unit 12, and other facial expressions. The mental states that may be inferred about a potential buyer or potential buyers of a product based on the mental state data which was collected may include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

Valence may be based on a moment-by-moment measure of a person being favorably or negatively disposed. A computer system may have been trained based on various facial expressions and head gestures to determine and classify the person's favorable or negative perspective. In some cases, smiles and brow lowers may be used as part of the positive or negative valence determination, respectively. A pattern of facial movement such as optical flow may be used along with upward or downward movement to determine and evaluate valence. The facial movements may be corrected for overall head movement. Head motion toward or away from a screen may be factored into valence determination, with motion toward the screen possibly indicating interest. In some cases, head motion may need to be corrected for movement closer to a screen caused by an effort to read a smaller font. In order to train the computer system, some data may have been previously labeled by a human expert. In some embodiments, a range from −1 to +1 may be used to describe valence with a value of 0 being neutral. In some cases a group of people's responses can be aggregated to yield a valence for the group. Some analyses may result in a valence quotient or a valence mean. A valence quotient norm may be determined. The valence quotient norm may be used to evaluate valence results across exposures to a product or between multiple products. In some analyses a minimum and/or maximum valence may be determined. Depending on the mental state data used to determine valence, error limits (such as error bars) may also be evaluated for valence.

The flow 100 continues with validation of the statistical models 160. The validation may include validating the one or more statistical models that were determined to be appropriate to the analysis of the mental state data collected from a potential buyer or a plurality of potential buyers who experienced a product. The validating may further include one or more of checking the one or more statistical models and optimizing coefficients for the one or more statistical models. Thus, for example, a “best fit” may be achieved between the mental state data collected and the one or more statistical models.

The flow 100 continues with projecting purchase intent 170 based on the mental state information gathered from a potential buyer or a plurality of potential buyers who experience a product. Part of the evaluation process for a product may include the projection of a potential buyer's or a plurality of potential buyers' buying likelihood. People may be presented with multiple products. The buying likelihood prediction may include, but is not limited to, which product the person found most appealing and, thus, which product the person is most likely to purchase. Similarly, the buying likelihood prediction may include, but is not limited to, which product the person found unappealing and, thus, which product the person might not consider for purchase. Embodiments of the present invention may determine correlations between mental state and likely purchase behavior. Based on probabilities, other statistics, and various statistical models that result from or have been fitted to the collected mental state data from potential buyers of a product, that product can be projected as either likely to be purchased or not likely to be purchased. The projecting of the purchase intent may be based on a variety of parameters and factors that may include, but are not limited to, the fastest decay for the electrodermal activity, other electrodermal activity, other mental state analysis, and the like. The flow 100 may include correlation of purchase intent prediction with self-reported purchase intent. The reported purchase intent, gathered from self-report data from a person or a plurality of people, may include one of a plan to purchase and a history of purchasing. Various steps in the flow 100 may be changed in order, repeated, omitted, or the like without departing from the disclosed inventive concepts. Various embodiments of the flow 100 may be included in a computer program product embodied in a non-transitory computer readable medium that includes code executable by one or more processors.

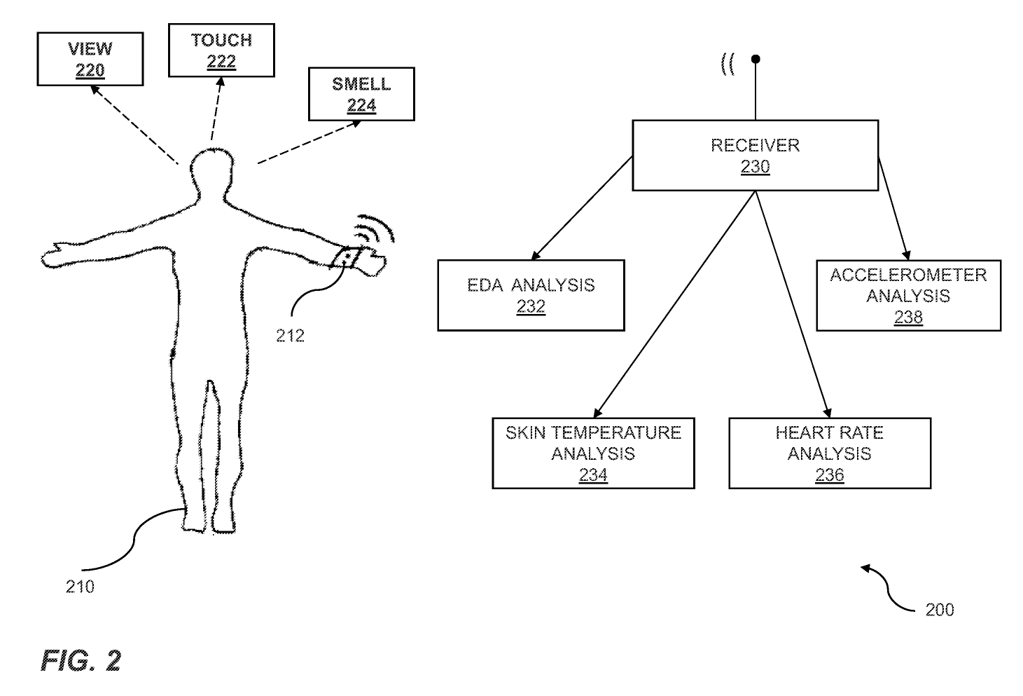

FIG. 2 is a system diagram representing physiological analysis 200 of a person 210 as she or he experiences a product. The experiencing of a product may include one or more of smelling, viewing, touching, and so on. In embodiments, a plurality of people may be monitored as they experience a product. A person or a plurality of people may be presented with a product or a rendering of a product. The person or plurality of people may interact with a product. The person or plurality of people may be able to touch the product, smell the product, and the like. In embodiments, various renderings of the product may be presented to the person or plurality of people. The rendering of a product may include a series of images, a video, a series of sketches, an animatic, or the like. The rendering may comprise images, text, background, video, and the like. In embodiments, any or all these elements, a combination of multiple instances of these elements, or other elements may be present. Experience of the product may also include displaying on an electronic display a rendering related to a product. The electronic display may be any electronic display, including but not limited to, a computer display, a laptop screen, a net-book screen, a tablet computer screen, a cell phone display, a mobile device display, a television, a projector, or the like. The product may include any type of product.

Physiological data may be gathered from a person or a plurality of people as they experience a product. A physiological monitoring device 212 may be attached to a person 210. The monitoring device 212 may be used to capture a variety of types of physiological data from a person 210 as the person experiences and interacts with a product. The physiological data may include electrodermal activity among other types of physiological data. The physiological data that may be collected may include, but is not limited to, electrodermal data, skin temperature, heart rate, accelerometer data, and the like. In embodiments, a plurality of people may be monitored as they view and interact with a product.

The person 210 may experience and interact with a product in a variety of ways. For example, the person 210 may view 220 a product directly, or may view a rendering of a product using a variety of electronic means. In embodiments, the person may interact with a product by touching 222 the product. In embodiments, the person may interact with a product by smelling 224 the product. In embodiments, a plurality of people may be monitored as they view, touch, small, and otherwise interact with a product.

Physiological data collected from a person 210 may be transmitted wirelessly to a receiver 230. In embodiments, physiological data from a plurality of people may be transmitted to a receiver 230 or to a plurality of receivers. In embodiments, the various types of transmitted physiological data can include, but are not limited to, electrodermal activity, skin temperature, heart rate, accelerometer data, and the like. Wireless transmission may be accomplished by any of a variety of means including, but not limited to, IR, Wi-Fi, Bluetooth, and the like. In embodiments, the physiological data can be sent from a person to a receiver via tethered or wired methods.

Various types of analysis may be performed on the physiological data gathered from a person or a plurality of people as they experience a product. For example, electrodermal activity 232 data may be analyzed for specific characteristics of interest. For example, the electrodermal activity data may be analyzed to determine a specific activity's peak duration, peak magnitude, onset rate, delay rate, and the like.

Additional types of analysis may be performed on the physiological data gathered from a person or a plurality of people as they experience a product. For example, skin temperature analysis 234 may be performed to measure skin temperature, temperature change rate, temperature trending, and the like. Heart rate analysis 236 may also be performed. Analysis of heart rate may include heart rate, changes in heart rate, and the like. Further analysis of physiological data may include accelerometer analysis 238. Accelerometer data analysis may include activity, rate of activity, and the like. In embodiments, other types of analysis can be performed on physiological data gathered from a person or a plurality of people as they experience a product.

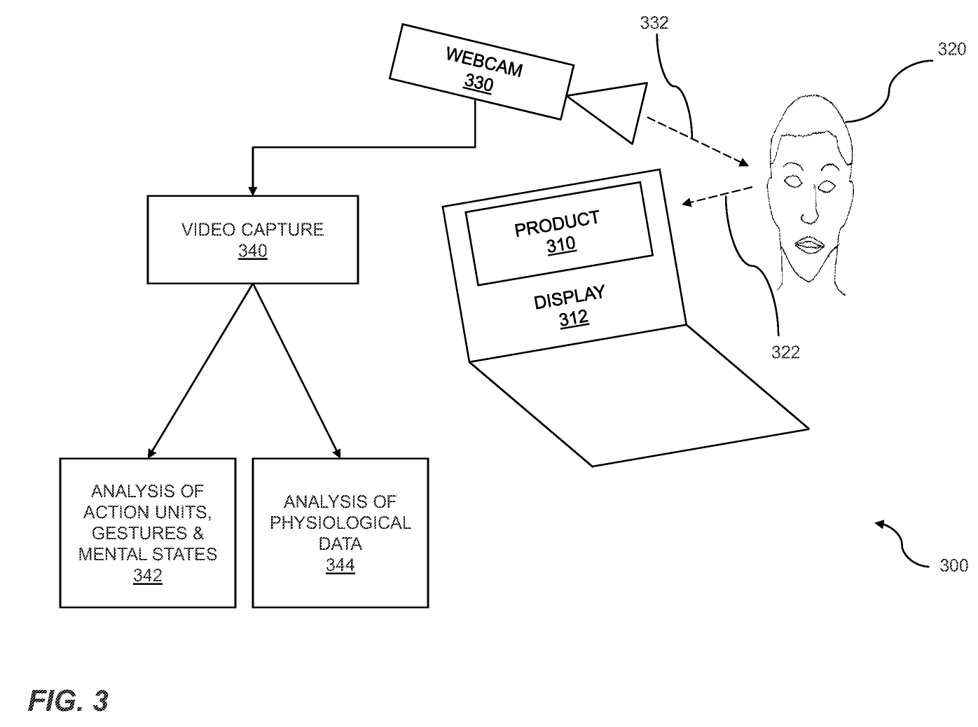

FIG. 3 is a diagram for capturing facial responses to a product 310. A person 320 or people may view or otherwise experience a product. The viewing may include viewing the product on an electronic display. A person 320 has a line-of-sight 322 to a display 312. While one person has been shown, in practical use, embodiments of the present invention may analyze groups comprised of tens, hundreds, thousands of people, or more. In embodiments, each person has a line of sight 322 to the product 310 rendered on a display 312. The product 310 may be any type of product. Multiple variations of the product may be rendered on the display 312.

The display 312 may be any electronic display, including but not limited to, a computer display, a laptop screen, a net-book screen, a tablet computer screen, a cell phone display, a mobile device display, a remote with a display, a television, a projector, or the like. In embodiments, a webcam 330 is configured and disposed such that it has a line-of-sight 332 to the person 320. A webcam, as the term is used herein, may refer to a video camera, still camera, thermal imager, CCD device, phone camera, three-dimensional camera, depth camera, multiple webcams used to show different views of a person, or any other type of image capture apparatus that may allow data captured to be used in an electronic system. In one embodiment, a webcam 330 is a networked digital camera that may take still and/or moving images of the person's face 320 and possibly person's body 320 as well. A webcam 330 may be used to capture one or more of the facial data and the physiological data. In embodiments, the facial data from the webcam 330 is received by a video capture module 340 which may decompress the video into a raw format from a compressed format such as H.264, MPEG-2, or the like.

The raw video data may then be processed for analysis of facial data, action units, gestures, mental states 342, and the like. The facial data may further comprise head gestures. The facial data itself may include information on one or more of action units, head gestures, smiles, brow furrows, squints, lowered eyebrows, raised eyebrows, attention, and the like. The action units may be used to identify smiles, frowns, and other facial indicators of mental states. Gestures may include tilting the head to the side, leaning forward, a smile, a frown, as well as many other gestures. Physiological data may be analyzed 344. Physiological data may be obtained through the webcam 330 without contacting the individual person. Respiration, heart rate, heart rate variability, perspiration, temperature, and other physiological indicators of mental state can be determined by analyzing the images. The physiological data may also be obtained by a variety of sensors, such as electrodermal sensors, temperature sensors, and heart rate sensors.

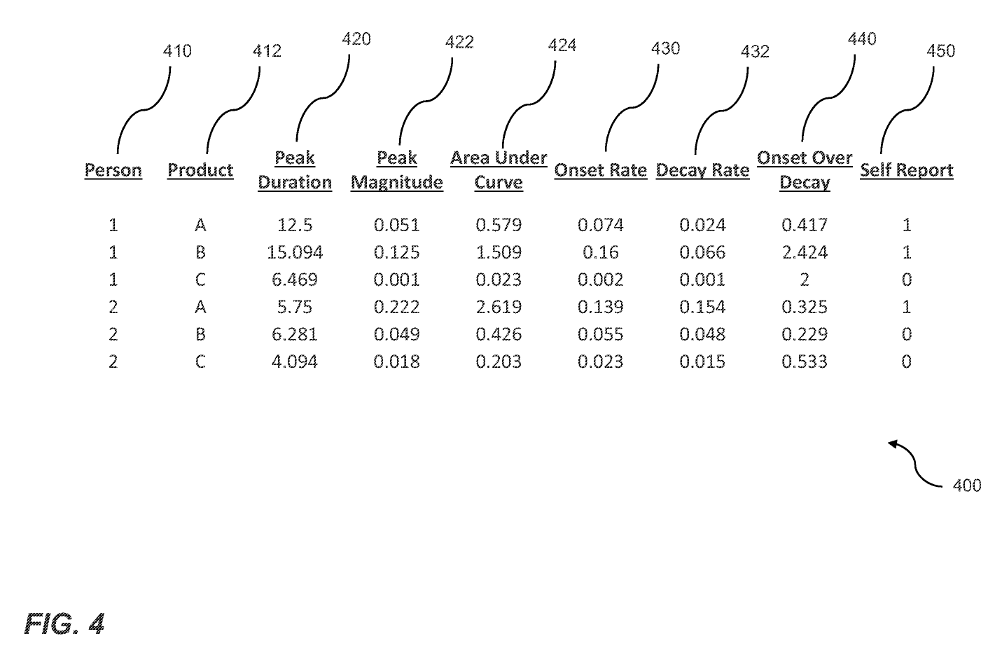

FIG. 4 is an example portion of a data spreadsheet for statistical analysis of purchase intent 400. Various types of data may be collected from a potential buyer or a plurality of potential buyers who are experiencing a product. In some embodiments, the data collected may include physiological data, facial data, actigraphy data, and the like. The facial data collected may include one or more of valence and action items. The action items may include action unit 2, action unit 4, action unit 12, and the like. The physiological data may include one or more of electrodermal response, heart rate, respiratory rate, and the like. The data collected may be stored in any appropriate way including, but not limited to, a spreadsheet.

The spreadsheet 400 may include a person field 410 to denote which person is experiencing a product. The mark in the Person 410 field may be a number, a letter, a name, or another signifier appropriate to the field. Any number of persons may be listed in the Person field 410.

The spreadsheet 400 may include a Product field 412 to denote which product is being experienced. The Product field 412 may be a number, a letter, a name, or any other signifier appropriate to the field. Any number of products may be listed in the Product field 412.

The spreadsheet 400 may include various fields related to physiological data gathered from the person or plurality of people experiencing a product or products. For example, a field may be present which denotes peak duration 420 of electrodermal response. The units for this field might be microseconds, milliseconds, seconds, minutes, or another time unit appropriate to the field. The spreadsheet 400 may include a field for peak magnitude 424 of a physiological parameter. For example, a peak magnitude for electrodermal response may be included. The units for peak magnitude may be any units appropriate to the field. For example, the units for peak magnitude of electrodermal response may be microsiemens, millisiemens, siemens, or other appropriate units.

The spreadsheet 400 may include a field for area under a curve 424. For example, the area under the curve 424 value is shown for a curve representing the peak magnitude of electrodermal response, as a person experiences a given product. The units for area under the curve field 424 may be micro siemens-seconds or any other units appropriate to the field.

The spreadsheet 400 may include a field for onset rate 430. For example, an onset rate field 430 may show the onset rate of the electrodermal response of a person experiencing a product. The units for the onset rate field 430 may be micro siemens per second or any other units appropriate to the field.

The spreadsheet 400 may include a field for decay rate 432. For example, a field showing the decay rate 432 of electrodermal response of a person experiencing a product may be present. The units for decay rate field 432 may be micro siemens per second or any other units appropriate to the field. The analyzing may include evaluating a fastest decay for the electrodermal activity. Evaluation may be based on electrodermal response or other physiological measurement.

The spreadsheet 400 may include a field for comparison of various fields. For example, the spreadsheet 400 may include a field for determining onset over decay 440. So, for example, a field showing the onset over decay 440 of electrodermal response of a person experiencing a product may be present. In the example given, onset over decay 440 is unitless.

The spreadsheet 400 may include a field for self-reporting data 450. The self-reporting data may be collected as part of a process for predicting purchase intent. The self-report data may be collected by a number of means, including, but not limited to, the person experiencing the product filling out a questionnaire, answering verbal questions, and the like. The self-report data may be collected in real time at the time the person experiences the product, at a later time, and the like. For example, the self-report data field 450 may show self-report data collected from a person or people experiencing a product. In some embodiments, the self-report data displayed may represent purchase intent. In some embodiments, the purchase intent is represented as a binary value. In embodiments, the purchase intent of a potential buyer may be represented by a range of numbers (i.e. 1 to 10, 1 to 100, etc.), a probability, a description, a short answer, and the like. For the example given, the self-report data may have a value of one (1) or zero (0), where 1 may indicate True and 0 may indicate False. Thus, self-reporting data may be displayed as a binary value (i.e. Yes=1, No=0), a range of values (i.e. 1 to 10, 1 to 100, etc.), a probability, and the like. As noted, in embodiments, the purchase intent can be represented as a probability.

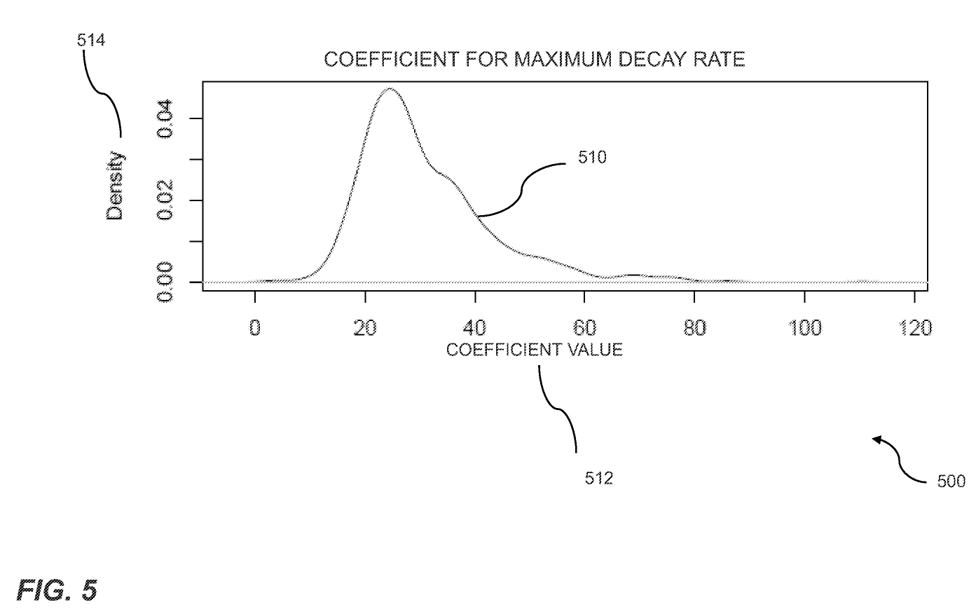

FIG. 5 is a graph of coefficient values 500. Various statistical models may be used as part of the analysis of data collected from a potential buyer or potential buyers as they experience a product. The analysis may be performed as part of a prediction of purchase intent. The choice of statistical model may have an impact on the effectiveness of predicting purchase intent. Thus, various statistical models may be examined in order to validate purchase intent prediction effectiveness. Further, tuning various model coefficients may be necessary to validate a choice of model, where the validating may include one or more of checking the one or more statistical models and may include optimizing coefficients for the one or more statistical models.

Various types of physiological and facial data may be collected during observation of a person or people as they experience a product. For example, types of collected facial data may include valence, action unit 2, action unit 4, action unit 12, and the like. These data types may then be used to calculate a probability. That probability may then in turn be used to predict purchase intent. The probability may be a function of physiology. In some cases electrodermal activity may be analyzed to predict purchase intent. For example, purchase intent probability 500 may be described by the following example equation:

$$P = \frac{1}{1 + {e}^{{β}_{0} + {β}_{1} X}}$$

In the preceding equation, P is a probability of purchase labeled as density 514, β0 (Beta 0) is a constant, β1 (Beta 1) is a coefficient, and X is a probability of, for example, a type of facial expression. For example, X may represent a probability of AU-02 (eyebrow raise) for a number of people experiencing a product. The number of people may be 10, 100, 1000, or any number appropriate for the statistical analysis. In another example, X may represent the maximum decay rate found in peaks of the electrodermal activity (EDA) signal from a sample of 1000 people experiencing a product. In this example, for each sample, peaks are detected for each sample and decay rates are calculated for each peak. The maximum decay rate found in each sample may be used for this calculation. A coefficient β1 for maximum decay rate may be plotted 510 based on the statistical model fit to the data. The resulting approximate probability density 514 of β1 may be determined by refitting a statistical model to thousands or subsamples from the original sample. Values that result from a statistical analysis may be relevant to a prediction of purchase intent. Stability or instability in the probability density may inform model reliability.

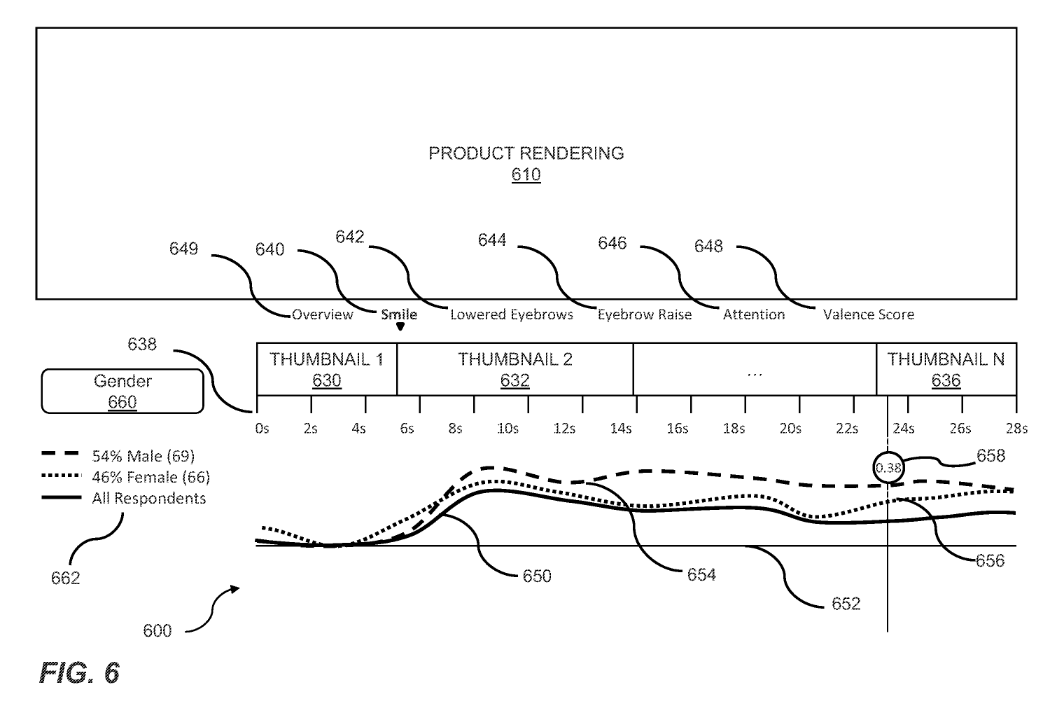

FIG. 6 is a graphical representation of mental state analysis. Mental state analysis may be shown graphically for product purchase intent analysis of people experiencing a product. The graphical representation may be presented on an electronic display. In one embodiment, a window 600 may be a dashboard display. The display may be a television monitor, projector, computer monitor (including a laptop screen, a tablet screen, a net-book screen, and the like), a cell phone display, a mobile device, or other electronic display. An example window 600 is shown which may include, for example, a rendering of a product 610 along with associated mental state information. In some embodiments, the rendering 610 is a video of a product. A user may be able to select among a plurality of product renderings using various buttons and/or tabs. The user interface allows a plurality of parameters to be displayed as a function of time, synchronized to the product rendering 610. Various embodiments may have any number of selections available for the user, and some may be other types of renderings instead of video. A set of thumbnail images for the selected rendering—which in the example shown includes Thumbnail 1 630, Thumbnail 2 632, through Thumbnail N 636—may be shown below the rendering along with a timeline 638. The thumbnails may show a graphic “storyboard” of the product rendering. This storyboard may assist a user in identifying a particular scene or location within the product rendering. Some embodiments may not include thumbnails, or may have a single thumbnail associated with the rendering, while other embodiments may have thumbnails of equal length, and still other embodiments may have thumbnails of differing lengths. In some embodiments, the start and/or end of the thumbnails is determined based on changes in the captured mental states associated with the rendering, while in other embodiments, the start and/or end of the thumbnails is based on particular points of interest in the product rendering. Thumbnails of one or more people may be shown along the timeline 638. The thumbnails of people may include peak expressions, expressions at key points in the product rendering 610, and the like.

The mental state information may be analyzed to produce an aggregated mental analysis which may be used in the projecting of purchase intent. Some embodiments may include the ability for a user to select a particular type of mental state information for display using various buttons or other selection methods. The mental state information may be based on one or more descriptors. The one or more descriptors may include, but are not limited to, one of AU4, AU12, and valence. The descriptors may include electrodermal activity. For example, in the dashboard shown, a window 600 shows smile mental state information as the user may have previously selected the Smile button 640. Other types of mental state information that may be available for user selection in various embodiments may include the Lowered Eyebrows button 642, Eyebrow Raise button 644, Attention button 646, Valence Score button 648 or other types of mental state information, depending on the embodiment. An Overview button 649 may be available to allow a user to show graphs of the multiple types of mental state information simultaneously. The mental state information may include probability information for one or more descriptors, and the probabilities for the one of the one or more descriptors may vary for portions of the product rendering.

Because the Smile option 640 has been selected in the example shown, a smile graph 650 may be shown against a baseline 652 showing the aggregated smile mental state information of the plurality of individuals from whom mental state data was collected for the product. The male smile graph 654 and the female smile graph 656 may be shown so that the visual representation displays the aggregated mental state information. The mental state information may be demographically based, as viewers who comprise a particular demographic react to the product. The various demographically based graphs may be indicated using various line types as shown or may be indicated using color or other methods of differentiation. A slider 658 may allow a user to select a particular time of the timeline and show the value of the chosen mental state for that particular time. The mental states can be used to evaluate the value of the product.

In some embodiments, various types of demographically based mental state information can be selected using the demographic button 660. Such demographics may include gender, age, race, income level, education, or any other type of demographic including dividing the respondents into those respondents who had higher reactions from those with lower reactions. A graph legend 662 may be displayed, indicating the various demographic groups, the line type or line color for each group, the percentage of total respondents and/or absolute number of respondents for each group, and/or other information about the demographic groups. The mental state information may be aggregated according to the demographic type selected. Thus, aggregation of the mental state information is performed on a demographic basis so that mental state information is grouped based on the demographic basis in some embodiments. As an example of demographically based aggregation, a product developer may be interested in observing the mental state of a particular demographic group as they react to a product under development.

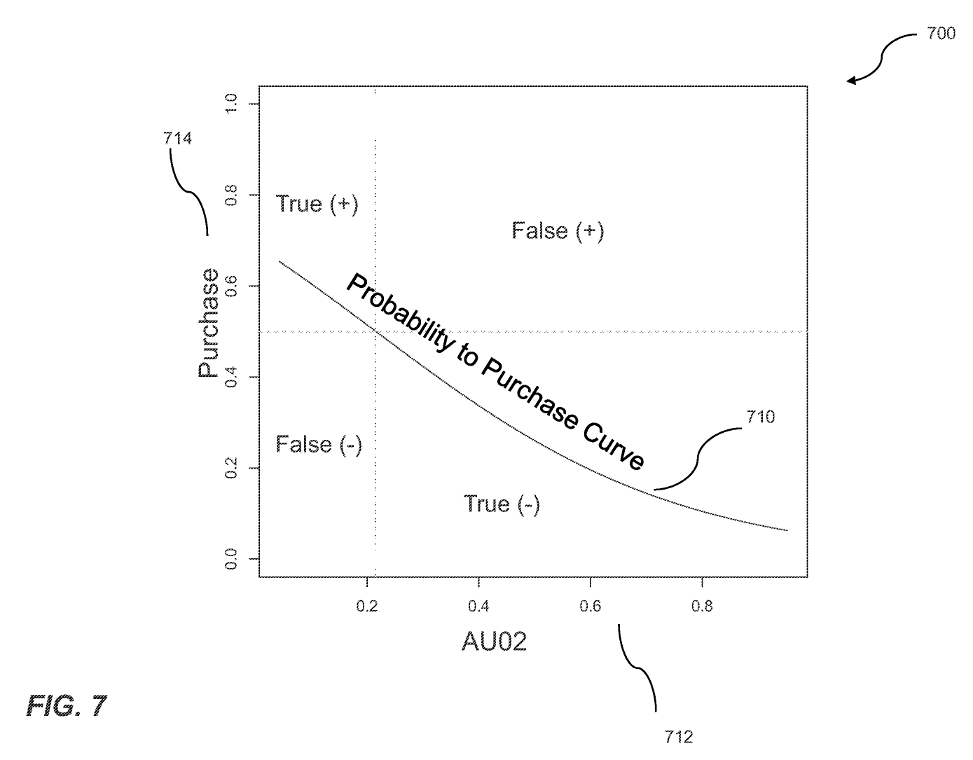

FIG. 7 is a graph of purchase probability 700. Various statistical models may be used as part of the analysis of data collected from a potential buyer or potential buyers as they experience a product. The analyzing may include fitting statistical models to the mental state data. The extent to which a statistical model may be effectively fitted to the collected mental state data may have a direct impact on the prediction of purchase intent.

The graph of purchase probability 700 may represent a “best fit” between, for example, facial data action units and a statistical model. The Probability to Purchase curve 710 represents an example fit of a statistical model. The model may be based on the standard deviation of a given facial action unit, for example, the standard deviation of facial action unit AU-02. The actual standard deviation values may be directly used, or they may be normalized to a scale of zero to one or any other appropriate scale. In some embodiments, electrodermal activity can be used to model purchase intent.

For a given facial action unit, a purchase intent probability may be estimated. For example, for a given value 712 of auction unit 2 (AU-02), a purchase probability 714 may be estimated. The analysis may be performed as part of a prediction of purchase intent. The choice of statistical model may have an impact on the effectiveness of predicting purchase intent. Thus, various statistical models may be examined in order to validate purchase intent prediction effectiveness. Further, tuning of various model coefficients may be necessary to validate a model choice, where the validating may include one or more of checking the one or more statistical models and optimizing coefficients for the one or more statistical models.

Based on the Probability to Purchase curve 710 for a given parameter, for example AU-02 712, the intent to purchase probability may be correlated with self-reported data collected from the potential buyer or potential buyers who experienced a product. In the graph 700, four quadrants may be identified. These quadrants correspond to the correlation between the purchase probability 714 and the self-reported intent to purchase. For example, the quadrant marked True (+) may correspond to the model correctly predicting that a product will be purchased. Similarly, the quadrant marked True (−) may correspond to the model correctly predicting that a product will not be purchased. Further, the quadrant marked False (+) may correspond to the model incorrectly predicting that a product will be purchased. Similarly, the quadrant marked False (−) may correspond to the model incorrectly predicting that a product will not be purchased.

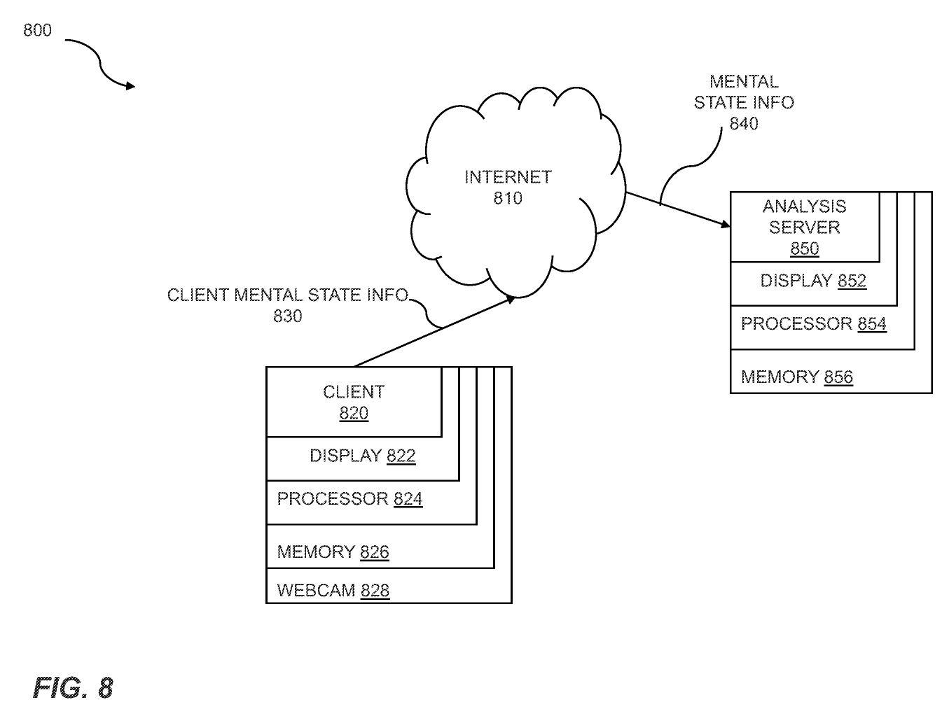

FIG. 8 is a system diagram for evaluating mental state information 800. The Internet 810, intranet, or other computer network may be used for communication between or among the various computers. A client computer 820 has a memory 826 which stores instructions, and one or more processors 824 attached to the memory 826 wherein the one or more processors 824 can execute instructions stored in the memory 826. The memory 826 may be used for storing instructions, for storing mental state data, for system support, and the like. The client computer 820 also may have an Internet connection to carry mental state information 830, and a display 822 which may present various products to one or more people. The client computer 820 may be able to collect mental state data from one or more people as they experience the product or products. In some embodiments, there are multiple client computers 820 that each collect mental state data from people as they experience a product. The product client computer 820 may have a camera 828 such as a webcam for capturing viewer interaction with a product, including video of the person or people experiencing a product. The camera 828 may refer to a webcam, a camera on a computer (such as a laptop, a net-book, a tablet, or the like), a video camera, a still camera, a cell phone camera, a mobile device camera (including, but not limited to, a forward facing camera), a thermal imager, a CCD device, a three-dimensional camera, a depth camera, multiple webcams used to capture different views of people, or any other type of image capture apparatus that may allow image data captured to be used by the electronic system.

Once the mental state data has been collected, the client computer 820 may upload information to a server or analysis computer 850, based on the mental state data from the plurality of people who experience the product. The client computer 820 may communicate with the server 850 over the Internet 810, intranet, some other computer network, or by any other method suitable for communication between two computers. In some embodiments, the analysis computer 850 functionality may be embodied in the client computer.

The analysis computer 850 may have a connection to the Internet 810 to enable mental state information 840 to be received by the analysis computer 850. Further, the analysis computer 850 may have a display 852 that may convey information to a user or operator; memory 856 which stores instructions, data, help information, and the like; and one or more processors 854 connected to the memory 856 wherein the one or more processors 854 can execute instructions. The memory 856 may be used for storing instructions, for storing mental state data, for system support, and the like. The analysis computer may use the Internet or another computer communication method to obtain mental state information 840. The analysis computer 850 may receive mental state information which is collected from a plurality of people who experience a product. The analysis computer may receive mental state information from the client computer or computers 820, and may aggregate mental state information on the plurality of people who experience the product.

The analysis computer 850 may process mental state data or aggregated mental state data gathered from a person or a plurality of people to produce mental state information about the person or plurality of people. In some embodiments, the analysis server 850 obtains mental state information 830 from the product client 820. In some cases, the mental state data captured by the product client 820 is analyzed by the concept client 820 to produce mental state information for uploading.

Based on the mental state information produced, the analysis server 850 may project a purchase intent value based on the mental state information. The analysis computer 850 may also associate the aggregated mental state information with the product rendering and with the collection of physiological data for the product being experienced.

In some embodiments, the analysis computer 850 receives aggregated mental state information based on the mental state data from the plurality of people who experience the product, and may present aggregated mental state information in a rendering on a display 852. In some embodiments, the analysis computer can be set up for receiving mental state data collected from a plurality of people as they experience the product in a real-time or near real-time embodiment. In at least one embodiment, a single computer may incorporate the client, server, and analysis functionality. People's mental state data may be collected from the client computer or computers 820 to form mental state information on the person or plurality of people experiencing a product. The mental state information resulting from the analysis of the mental state date of a person or a plurality of people may be used to project a purchase intent value based on the mental state information.

The system 800 may include a computer program product embodied in a non-transitory computer readable medium for learning purchase behavior, the computer program product comprising code for collecting mental state data from a plurality of people as they experience a product, code for analyzing the mental state data to produce mental state information, and code for projecting purchase intent based on the mental state information. The system 800 may include a memory which stores instructions and one or more processors attached to the memory wherein the one or more processors, when executing the instructions which are stored, are configured to collect mental state data from a plurality of people as they experience a product, analyze the mental state data to produce mental state information, and project purchase intent based on the mental state information.

Each of the above methods may be executed on one or more processors on one or more computer systems. Embodiments may include various forms of distributed computing, client/server computing, and cloud based computing. Further, it will be understood that for each flowchart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which implementations may be generally referred to herein as a “circuit,” “module,” or “system.”

A programmable apparatus that executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

What is claimed is:

1. A computer implemented method for learning purchase behavior comprising:
collecting mental state data from a plurality of people as they are experiencing a product;
analyzing the mental state data to produce mental state information; and
projecting purchase intent based on the mental state information.

2. The method of claim 1 wherein the experiencing includes one of smelling, viewing, or touching.

3. The method of claim 2 wherein the viewing includes viewing on an electronic display.

4. The method of claim 1 further comprising collecting self reporting from the plurality of people.

5. The method of claim 4 wherein the self reporting includes information on whether individuals, from the plurality of people, plan to purchase the product.

6. The method of claim 1 further comprising collecting information on whether individuals from the plurality of people eventually purchase the product.

7. The method of claim 1 wherein the analyzing the mental state data further includes pre-processing the mental state data, wherein the pre-processing comprises one or more of machine learning, filtering, smoothing, or segmenting by time.

8. The method of claim 1 wherein the analyzing the mental state data further comprises post-processing the mental state data wherein the post-processing includes one or more of detecting peaks, detecting durations, detecting magnitudes, detecting rise times, or detecting fall times.

9. The method of claim 1 wherein the analyzing further comprises fitting statistical models to the mental state data.

10. The method of claim 9 further comprising selecting one or more of the statistical models for use in the projecting of the purchase intent.

11. The method of claim 10 wherein the selecting is based on a search of the statistical models to identify a subset of the statistical models which correlate to a reported purchase intent.

12. The method of claim 11 wherein the reported purchase intent includes one of a plan to purchase or a history of purchasing.

13. The method of claim 10 further comprising validating the one or more statistical models.

14. The method of claim 13 wherein the validating includes one or more of checking the one or more statistical models and optimizing coefficients for the one or more statistical models.

15. The method of claim 1 wherein the purchase intent is represented as a binary value.

16. The method of claim 1 wherein the purchase intent is represented as a probability.

17. The method of claim 1 further comprising aggregating the mental state information into an aggregated mental state analysis which is used in the projecting.

18. The method of claim 1 wherein the mental state data includes one of a group comprising physiological data, facial data, or actigraphy data.

19. The method of claim 18 wherein the facial data includes one or more of valence, action unit 4, or action unit 12.

20. The method of claim 18 wherein the physiological data includes electrodermal activity.

21. The method of claim 20 wherein the analyzing includes evaluating a fastest decay for the electrodermal activity.

22. The method of claim 18 wherein a webcam is used to capture one or more of the facial data or the physiological data.

23. The method of claim 1 further comprising inferring mental states about the product based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, or curiosity.

24. A computer program product embodied in a non-transitory computer readable medium for learning purchase behavior, the computer program product comprising:
code for collecting mental state data from a plurality of people as they experience a product;
code for analyzing the mental state data to produce mental state information; and
code for projecting purchase intent based on the mental state information.

25. A computer system for learning purchase behavior comprising:
a memory which stores instructions;
one or more processors attached to the memory wherein the one or more processors, when executing the instructions which are stored, are configured to:
collect mental state data from a plurality of people as they experience a product;
analyze the mental state data to produce mental state information; and
project purchase intent based on the mental state information.

26. A computer implemented method for learning purchase behavior comprising:
collecting mental state data from a plurality of people as they experience a product, wherein the experience includes one of touching and smelling, and wherein the mental state data includes electrodermal activity;
analyzing the mental state data to produce mental state information wherein the analyzing includes evaluating a fastest decay for the electrodermal activity; and
projecting purchase intent based on fastest decay for the electrodermal activity.
